(19) United States
(12) Patent Application Publication
(10) Pub. No.: US 2025/0249544 A1
(43) Pub. Date: Aug. 7, 2025

(54) SANDING MACHINE

(71) Applicant: Nanjing Chervon Industry Co., Ltd., Nanjing (CN)

(72) Inventors: Lisong Zhang, Nanjing (CN); Huan Liu, Nanjing (CN)

(21) Appl. No.: 19/189,487

(22) Filed: Apr. 25, 2025

Related U.S. Application Data
(63) Continuation of application No. PCT/CN2023/128654, filed on Oct. 31, 2023.

(30) Foreign Application Priority Data
Nov. 18, 2022 (CN) 202211445601.4
Oct. 26, 2023 (CN) 202311405480.5
Oct. 26, 2023 (CN) 202322892671.0

(51) Int. Cl. B24B 23/02; B24B 55/10; B25F 5/00; B25F 5/02

(52) U.S. Cl. CPC B24B 23/02; B24B 55/102; B25F 5/001; B25F 5/006; B25F 5/02

(57) ABSTRACT

A sander includes a body and a battery pack, The body includes a housing, an electric motor, a base plate, and a battery pack coupling portion, where the battery pack is mountable to the battery pack coupling portion; the electric motor is disposed in the housing and has a rotatable motor shaft; laminations of the electric motor are located between the battery pack and an output shaft; and the angle γ between an axis of the motor shaft and a plane where the base plate is located is greater than or equal to 0° and less than or equal to 25°.

### RELATED APPLICATION INFORMATION

This application is a continuation of International Application Number PCT/CN2023/128654, filed on Oct. 31, 2023, through which this application also claims the benefit under 35 U.S.C. § 119(a) of Chinese Patent Application No. CN 202211445601.4, filed on Nov. 18, 2022, Chinese Patent Application No. CN 202311405480.5, filed on Oct. 26, 2023, and Chinese Patent Application No. CN 202322892671.0, filed on Oct. 26, 2023, which applications are incorporated herein by reference in their entireties.

### BACKGROUND

A sander is a commonly used sanding tool for polishing and sanding surfaces of woods, plastics, stones, metals, and other materials through the oscillation of a base plate. While implementing a sanding function, the sander generally should also have a relatively small volume and weight to satisfy the expectation of a user for ease of operation and improve user experience. When the sander has a relatively small volume, if a relatively large battery pack is mounted, the whole machine is unbalanced in weight, and thus the base plate of the sander cannot be stably placed on a horizontal plane; if a relatively small battery pack is mounted, the battery life cannot be ensured.

Additionally, limited by an internal arrangement, the overall height of the sander cannot be made very small, and the sander occupies a relatively large space, making it difficult to satisfy the requirement of the user for a compact sander.

### SUMMARY

A sander includes a housing; a battery pack coupling portion to which a battery pack is mountable; an electric motor disposed in the housing and having a rotatable motor shaft; and a base plate. An overall height H of the sander is less than or equal to 105 mm.

In an example, the sander further includes an output shaft, where the output shaft drives the base plate to rotate; and laminations of the electric motor are located between the battery pack and the output shaft.

In an example, the angle γ between an axis of the motor shaft and a plane where the base plate is located is greater than or equal to 0° and less than or equal to 25°.

In an example, when the battery pack is mounted to the sander, the center of gravity of the sander is located between the battery pack and the output shaft.

In an example, the overall height H is less than or equal to 100 mm.

In an example, the sander further includes a transmission assembly, where an input end of the transmission assembly is connected to the motor shaft, and an output end of the transmission assembly is connected to the output shaft.

In an example, the sander further includes an output shaft, where the output shaft drives the base plate to rotate; the battery pack is mountable to the battery pack coupling portion; and on a plane parallel to the base plate, an axis of the output shaft is defined as the center, with a Y axis being parallel to a mounting plane of the battery pack and an X axis being perpendicular to the Y axis, where the angle α between an axis of the motor shaft and a positive direction of the X axis is greater than or equal to 20°.

In an example, the angle γ between an axis of the motor shaft and a plane where the base plate is located is greater than or equal to 5° and less than or equal to 15°.

In an example, a control board is provided in the housing, and the motor shaft is spaced apart from the control board.

In an example, the sander further includes an operation key disposed at the top, on a side, or at the front end of the housing.

In an example, the operation key is capable of controlling start and stop of the electric motor and/or regulating a rotational speed of the electric motor.

In an example, the sander further includes a display screen located at the top, on a side, or at the front end of the front side of the housing.

In an example, when the battery pack is mounted onto the battery pack coupling portion, the height of the battery pack in an up and down direction is less than or equal to the length of the battery pack in a left and right direction.

In an example, an air duct is provided on the housing, an air outlet is provided at an end of the air duct, the air outlet faces the rear side of the housing, and the air duct extends in an arc shape in a direction away from the housing.

In an example, the sander further includes a gearbox, where the transmission assembly is disposed in the gearbox.

In an example, the weight of the gearbox is greater than or equal to 20 g and less than or equal to 350 g.

A sander includes a body and a battery pack. The body includes a housing; a battery pack coupling portion to which the battery pack is mountable; and a base plate. The body further includes an electric motor disposed in the housing and having a rotatable motor shaft; and an output shaft for driving the base plate to rotate. When the battery pack is mounted to the battery pack coupling portion, the body and the battery pack form a whole machine, and the center of gravity of the whole machine is located between the battery pack and the output shaft. An overall height H of the sander is less than or equal to 105 mm.

In an example, the weight of the whole machine is defined as a first weight W1, a maximum weight of the battery pack mountable to the body is defined as M0, and M0 is greater than or equal to 40% of W1.

In an example, the weight of the body is defined as a second weight W2, and W2 is greater than or equal to 800 g and less than or equal to 1100 g.

In an example, the weight of the battery pack is greater than or equal to 700 g and less than or equal to 1300 g.

A sander includes a body and a battery pack. The body includes a housing; a battery pack coupling portion to which the battery pack is mountable; an electric motor disposed in the housing and having a rotatable motor shaft; a base plate; and an output shaft for driving the base plate to rotate. Laminations of the electric motor are located between the battery pack and the output shaft. The angle γ between an axis of the motor shaft and a plane where the base plate is located is greater than or equal to 0° and less than or equal to 25°. When the battery pack is mounted to the battery pack coupling portion, the body and the battery pack form a whole machine, and the center of gravity of the whole machine is located between the battery pack and the output shaft.

In an example, a projection of the center of gravity of the whole machine on the base plate is located within a boundary of the base plate.

In an example, the sander further includes a transmission assembly, where an input end of the transmission assembly is connected to the motor shaft, and an output end of the transmission assembly is connected to the output shaft.

In an example, the sander further includes a gearbox, where the transmission assembly is disposed in the gearbox.

In an example, the weight of the gearbox is greater than or equal to 20 g and less than or equal to 350 g.

In an example, a projection of the electric motor on the base plate is located within a boundary of the base plate.

In an example, the sander further includes a bearing, where the bearing is located on a side of the motor shaft facing away from the output shaft, and a projection of the bearing on the base plate is located within the boundary of the base plate.

In an example, the weight of the whole machine is defined as a first weight W1, a maximum weight of the battery pack mountable to the body is defined as M0, and M0 is greater than or equal to 40% of W1.

In an example, the weight of the body is defined as a second weight W2, and W2 is greater than or equal to 800 g and less than or equal to 1100 g.

In an example, the weight of the battery pack is greater than or equal to 700 g and less than or equal to 1300 g.

A sander includes a body and a battery pack. The body includes a housing; a battery pack coupling portion to which the battery pack is mountable; an electric motor disposed in the housing and having a rotatable motor shaft; and a base plate. An overall weight of the sander is defined as a first weight W1, a maximum weight of the battery pack mountable to the body is defined as M0, and M0 is greater than or equal to 40% of W1. When the body is mounted with the battery pack and placed on a horizontal plane, the sander does not tilt.

### BRIEF DESCRIPTION OF THE DRAWINGS

FIG. 1 is a structural view one of a sander according to an example of the present application.

FIG. 2 is a side view one of a sander according to an example of the present application.

FIG. 3 is a sectional view of FIG. 2 taken along A-A.

FIG. 4 is a partial structural view one of a sander according to an example of the present application.

FIG. 5 is a partial structural view two of a sander according to an example of the present application.

FIG. 6 is a structural view of a gearbox according to an example of the present application.

FIG. 7 is an exploded view of some structures of a sander according to an example of the present application.

FIG. 8 is a partial structural view three of a sander according to an example of the present application.

FIG. 9 is a top view of some structures of a sander according to an example of the present application.

FIG. 10 is a schematic diagram one of an electric motor and a control board according to an example of the present application.

FIG. 11 is a schematic diagram two of an electric motor and a control board according to an example of the present application.

FIG. 12 is a structural view two of a sander according to an example of the present application.

FIG. 13 is a schematic diagram one of an operation key according to an example of the present application.

FIG. 14 is a schematic diagram two of an operation key according to an example of the present application.

FIG. 15 is a schematic diagram of an operation key and a display screen according to an example of the present application.

FIG. 16 is a top view of a sander according to an example of the present application.

FIG. 17 is a side view two of a sander according to an example of the present application.

FIG. 18 is a schematic view of an arrangement of an electric motor of a sander according to an example of the present application.

FIG. 19 is another schematic view of an arrangement of an electric motor of a sander according to an example of the present application.

FIG. 20 is a perspective view of a sander according to a new example of the present application.

FIG. 21 is a schematic view of mounting of an air duct of the sander in FIG. 20.

FIG. 22 is a sectional view of an air duct mounted to a first housing.

FIG. 23 is a partial enlarged view of a sealing groove.

FIG. 24 is a schematic view of an interior of the sander in FIG. 20.

FIG. 25 is a perspective view of a fan.

FIG. 26 is a side view of a fan.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

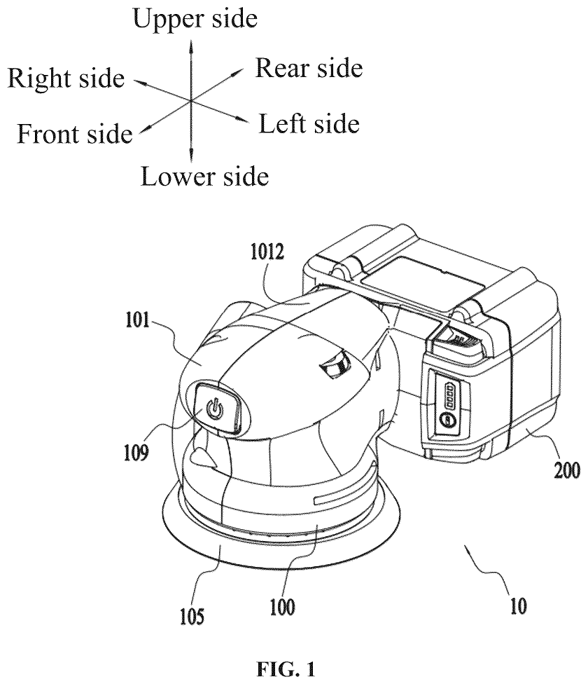

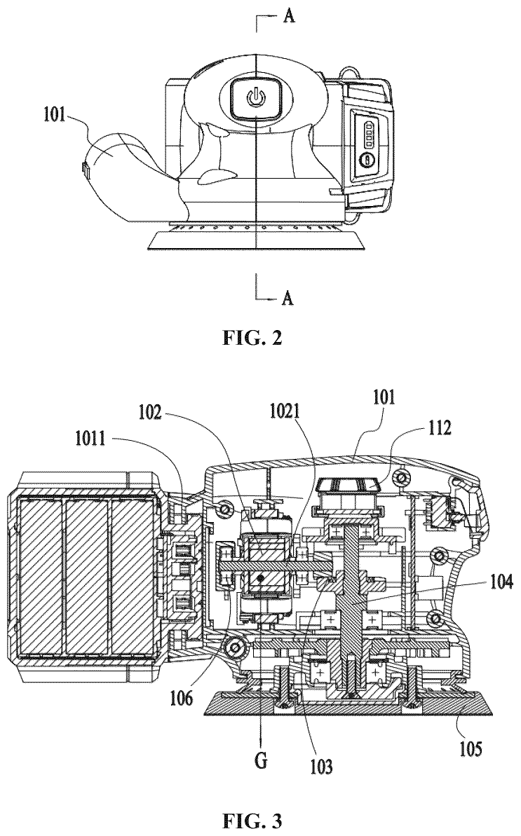

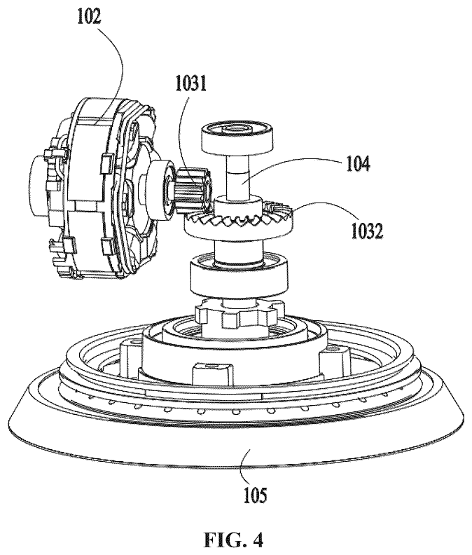

Referring to FIGS. 1 to 4, this example provides a sander including a body 100 and a battery pack 200. The battery pack 200 is detachably connected to the body 100. That is to say, the sander not mounted with the battery pack 200 is the body 100. The body 100 mounted with the battery pack 200 is defined as a whole machine 10.

The body 100 includes a housing 101, an electric motor 102, a transmission assembly 103, an output shaft 104, a base plate 105, and a battery pack coupling portion 1011. The battery pack 200 is mountable to the battery pack coupling portion 1011. The electric motor 102 is disposed in the housing 101 and has a rotatable motor shaft 1021. An input end of the transmission assembly 103 is connected to the motor shaft 1021, and an output end of the transmission assembly 103 is connected to the output shaft 104. The base plate 105 is located outside the housing 101 and is connected to the output shaft 104. The electric motor 102 may be a brushed electric motor or a brushless electric motor. The rotation of the motor shaft 1021 can drive the output shaft 104 to rotate so that the output shaft 104 drives the base plate 105 to rotate. A mounting surface is formed on the base plate 105, and the mounting surface can fix a sanding piece such as sandpaper to form a sanding bottom surface capable of performing sanding. It is to be understood that the sander may be a round sander, a triangular sander, a square sander, a special-shaped sander, or the like.

All laminations of the electric motor 102 are located between the battery pack 200 and the output shaft 104. When the battery pack 200 is mounted to the battery pack coupling portion 1011, the body 100 and the battery pack 200 form the whole machine 10, and the center of gravity of the whole machine 10 is located between the battery pack 200 and the output shaft 104. Thus, the weight distribution of the whole machine 10 is equalized, and the whole machine 10 does not tilt when a relatively heavy battery pack 200 is mounted, thereby ensuring the battery life of the sander. In FIG. 3, an arrow indicates the gravity G to which the whole machine 10 is subjected, and a starting position of the arrow is a position of the center of gravity of the whole machine 10.

A projection of the center of gravity of the whole machine 10 on the base plate 105 is located within a boundary of the base plate 105. The whole machine 10 may be placed on a horizontal plane, and the sanding bottom surface of the base plate 105 is in contact with the horizontal plane so that the whole machine 10 has a relatively large contact area with the horizontal plane. The projection of the center of gravity of the whole machine 10 on the base plate 105 is located within the boundary of the base plate 105, that is, the projection of the center of gravity of the whole machine 10 on the base plate 105 does not exceed a plane where the base plate 105 is located so that the whole machine 10 does not tilt. The plane where the base plate 105 is located is parallel to the mounting surface of the base plate.

The sanding piece may be disposed on the base plate 105, and the sanding piece may be sandpaper or another type of abrasive or polishing piece. The base plate 105 is provided with a dust suction port of the base plate 105 for sucking dust generated during operation.

It is to be understood that an axis of the output shaft 104 is perpendicular to the plane where the base plate 105 is located. In this example, an axis of the motor shaft 1021 is perpendicular to the axis of the output shaft 104. That is to say, the axis of the motor shaft 1021 is parallel to the plane where the base plate 105 is located. The angle between the axis of the motor shaft 1021 and the plane where the base plate 105 is located is equal to 0°.

The transmission assembly 103 is a bevel gear transmission assembly and includes a first bevel gear 1031 and a second bevel gear 1032 that mesh with each other, the first bevel gear 1031 is connected to the motor shaft 1021, and the second bevel gear 1032 is connected to the output shaft 104.

In this example, a projection of the electric motor 102 on the base plate 105 is located within the boundary of the base plate 105. The electric motor 102 is disposed at such a position that the counterweight of the whole machine 10 is relatively well balanced, the stability of the whole machine 10 is maintained, and the body 100 can be mounted with a relatively heavy battery pack 200 without tilting.

In this example, the laminations of the electric motor 102 are located between the battery pack 200 and the output shaft 104, and the layout is reasonable to ensure the balance of the whole machine 10. In an example, the electric motor 102 may be the brushless electric motor with low noise and a long lifetime.

The sander further includes a bearing 106, and the bearing 106 is located on a side of the motor shaft 1021 facing the battery pack coupling portion 1011, that is, a side of the motor shaft 1021 facing away from the output shaft 104. A projection of the bearing 106 on the base plate 105 is located within the boundary of the base plate 105, so as to ensure that the bearing 106 on the outermost side of the electric motor 102 is also located within a range of the base plate 105, thereby maintaining the stability of the whole machine 10, and enabling the body 100 to be mounted with a relatively heavy battery pack 200 without tilting.

The weight of the whole machine 10 is defined as a first weight W1, a maximum weight of the battery pack 200 mountable to the body 100 is defined as M0, and M0 is greater than or equal to 40% of W1. In some examples, M0 is greater than or equal to 43%, 45%, or 47% of W1. When M0 is equal to 50% of W1, the weight of the body 100 is approximately equal to the weight of the battery pack 200. According to the technical solutions disclosed in the present application, the electric motor 102 is horizontally disposed and a gearbox 107 with a certain mass is disposed, so as to ensure that the whole machine 10 of the sander does not tilt when the body 100 is mounted with the battery pack 200 and placed on the horizontal plane.

The weight of the body 100 is defined as a second weight W2, and W2 is greater than or equal to 800 g and less than or equal to 1100 g. In some examples, W2 is greater than or equal to 850 g and less than or equal to 1050 g. In some examples, W2 is greater than or equal to 900 g and less than or equal to 1000 g. In some examples, W2 may be 900 g or 950 g.

The weight of the battery pack 200 is greater than or equal to 650 g. Although the weight of the battery pack 200 is relatively large, the whole machine 10 has relatively high stability and does not tilt. In some examples, the weight of the battery pack 200 is greater than or equal to 700 g and less than or equal to 1300 g. In some examples, the weight of the battery pack 200 is greater than or equal to 750 g and less than or equal to 1300 g. In some examples, the weight of the battery pack 200 may be 800 g, 900 g, 1000 g, 1100 g, or 1200 g.

In some examples, when W2 is about 950 g, the weight of the battery pack 200 may be 460 g, 750 g, or 950 g. In some examples, the weight of the battery pack 200 may be approximately equal to W2. “About” or “approximately” refers to addition or subtraction by 5%. About 950 g refers to being greater than or equal to 950×(1-5%) g and less than or equal to 950×(1+5%) g.

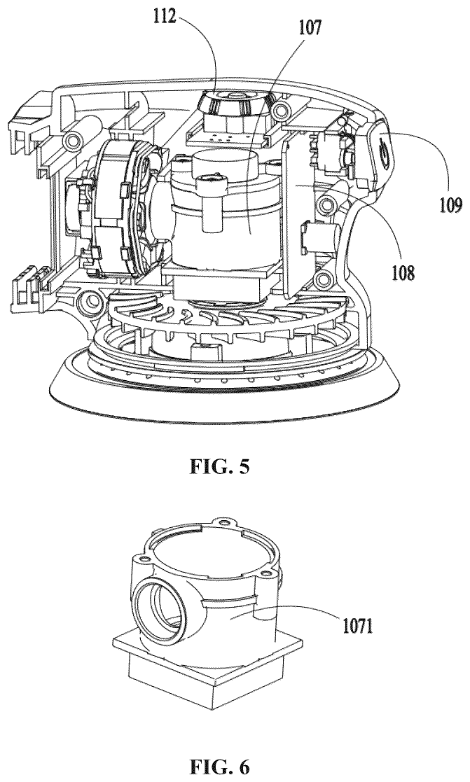

Referring to FIGS. 5 to 7, the sander further includes the gearbox 107, and the transmission assembly 103 is disposed in the gearbox 107. The gearbox 107 can relatively well balance the counterweight of the whole machine 10 and maintain the stability of the whole machine 10 so that the body 100 can be mounted with a relatively heavy battery pack 200 without tilting. The transmission assembly 103 is disposed in the gearbox 107, and the gearbox 107 positions the transmission assembly 103 to reduce noise generated during operation.

The weight of the gearbox 107 is greater than or equal to 20 g and less than or equal to 350 g. In some examples, the weight of the gearbox 107 is 100 g, 150 g, 200 g, or 250 g. In some examples, the gearbox 107 is made of a metal material. In an example, the gearbox 107 may be configured to be a semi-enclosed structure. Thus, the weight of the gearbox 107 can be adjusted so that a position of the center of gravity of the body 100 can be adjusted, which affects the maximum weight of the battery pack 200 mountable to the body 100.

The gearbox 107 is disposed in the housing 101, and a shock absorber is provided between the gearbox 107 and the housing 101 to reduce vibration. The shock absorber may be rubber or a vibration isolation pad.

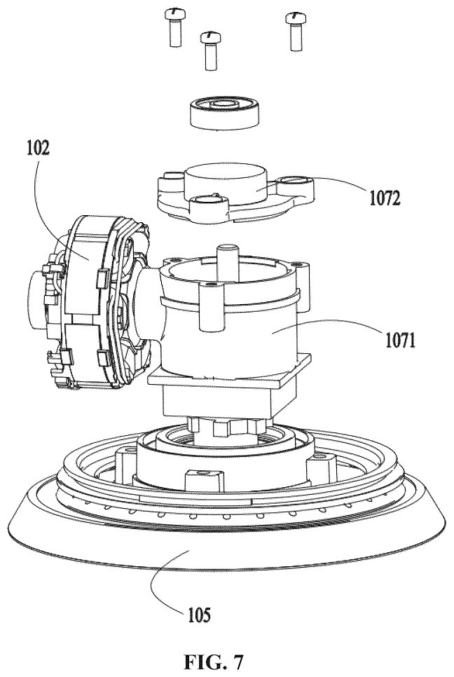

Specifically, referring to FIG. 7, the gearbox 107 includes a box body 1071 and a cover 1072, the output shaft 104 penetrates through the box body 1071, the cover 1072 is buckled at an opening at an end of the box body 1071, the cover 1072 is provided with a bearing cavity, a first bearing is mounted in the bearing cavity, and the output shaft 104 penetrates through the first bearing.

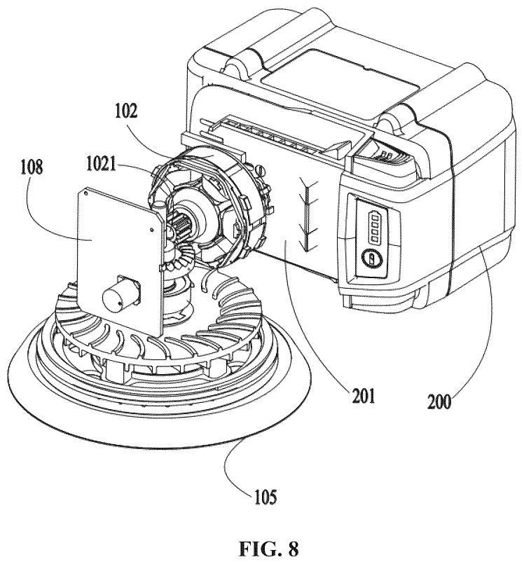

Referring to FIGS. 1, 3, and 8, the battery pack 200 includes a coupling surface 201, and the coupling surface 201 of the battery pack 200 is connected to the battery pack coupling portion 1011. The coupling surface 201 refers to a plane where connection terminals of the battery pack 200 are located, which may be a real plane or an imaginary plane. It is to be noted that in a direction in which the battery pack 200 is inserted and removed, the battery pack 200 has a longest dimension.

The direction in which the battery pack 200 is inserted and removed may be parallel to the plane where the base plate 105 is located. That the direction in which the battery pack 200 is inserted and removed is parallel to the plane where the base plate 105 is located includes insertion and removal along a left and right direction or insertion and removal along a front and rear direction. The insertion and removal along the left and right direction includes the case where the coupling surface 201 is perpendicular to the base plate 105 or the case where the coupling surface 201 is inclined relative to the base plate 105.

In this example, the battery pack 200 is inserted into or removed from the body along the left and right direction in FIG. 1, the coupling surface 201 of the battery pack 200 is substantially perpendicular to the base plate 105, and the battery pack 200 is coupled to the battery pack coupling portion 1011 of the body.

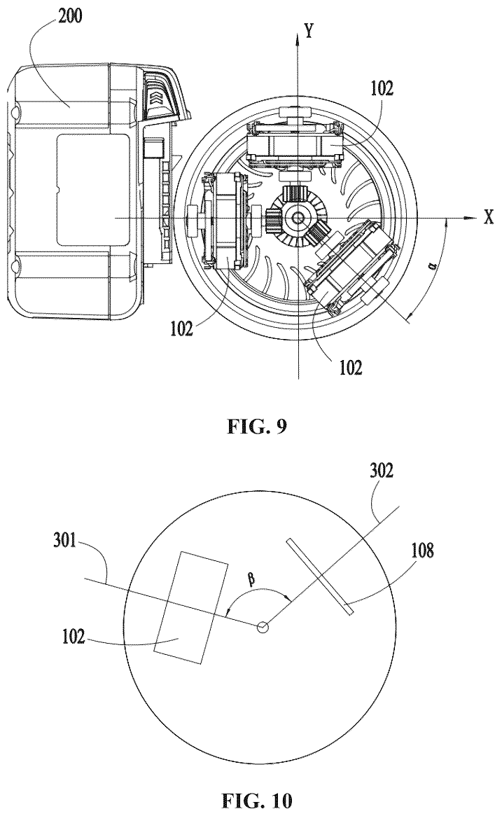

Referring to FIG. 9, on a plane parallel to the base plate 105, the axis of the output shaft 104 is defined as the center, with a Y axis being parallel to a mounting plane of the battery pack 200 and an X axis being perpendicular to the Y axis, where the angle α between the axis of the motor shaft 1021 and a positive direction of the X axis is greater than or equal to 20°. That is to say, the position of the electric motor 102 is not limited to the position between the battery pack 200 and the output shaft 104, and the electric motor 102 may be mounted at multiple positions in four quadrants formed by the X axis and the Y axis. It is to be understood that FIG. 9 shows three possible positions of the electric motor 102 rather than three electric motors 102.

Referring to FIGS. 1, 5, and 8, a control board 108 is disposed in the housing 101, the sander further includes an operation key 109, the operation key 109 is disposed on the housing 101, and the operation key 109 is electrically connected to the control board 108. The operation key 109 may control the start and stop of the electric motor 102 or may perform speed regulation. A speed regulation assembly 112 is provided in the housing 101, and the operation key 109 may control the speed regulation assembly 112 to perform speed regulation.

The motor shaft 1021 is spaced apart from the control board 108. Positions of the motor shaft 1021 and the control board 108 are not limited here as long as it is ensured that the motor shaft 1021 does not interfere with the control board 108 in the housing 101. In this example, the control board 108 is located in the front of the housing 101 to balance the counterweight of the whole machine 10.

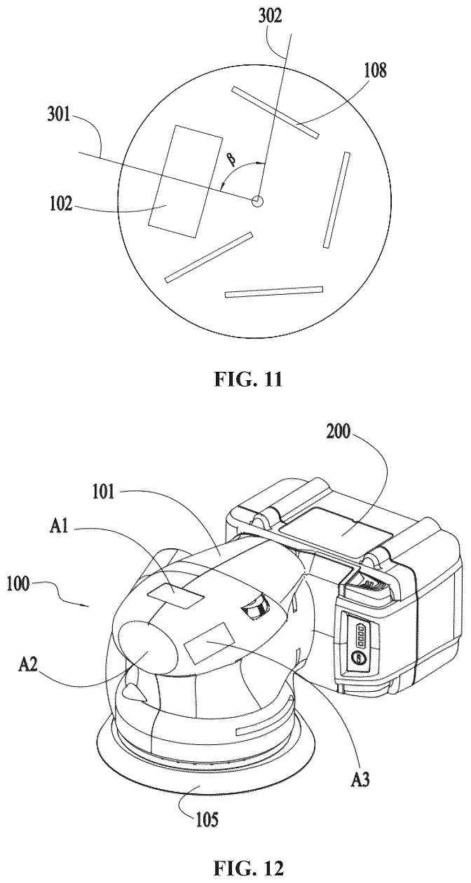

Referring to FIGS. 10 and 11, the control board 108 is parallel to the output shaft 104, a plane where the axis of the motor shaft 1021 and the axis of the output shaft 104 are located is defined as a first plane 301, a centerline of the control board 108 is parallel to the axis of the output shaft 104, a plane where the axis of the output shaft 104 and the centerline of the control board 108 are located is defined as a second plane 302, and the angle between the first plane 301 and the second plane 302 is P, where P is greater than or equal to 70°. It is to be understood that FIG. 11 shows four possible positions of the control board 108 rather than four control boards 108.

Generally, the control board 108 is rectangular, the centerline of the control board 108 is a centerline of the rectangle, and the centerline is parallel to the axis of the output shaft 104. When the control board 108 is circular, the centerline of the control board 108 is a diameter of the circle.

In an example, the operation key 109 may control the start and stop of the electric motor 102. As shown in FIG. 5, the speed regulation assembly 112 is disposed in the housing 101, and the speed regulation assembly 112 is a knob. In another example, the sander does not perform speed regulation through the speed regulation assembly 112 in the form of the knob in FIG. 5 but performs speed regulation through the operation key 109. Therefore, in an example, the operation key 109 can not only control the start and stop of the electric motor 102 but also perform speed regulation on the electric motor 102. Specifically, the operation key 109 may remain pressed for different durations to control the electric motor 102 to implement different functions. For example, the operation key 109 is long pressed to implement startup or shutdown, and the operation key 109 is short pressed to increase a rotational speed of the electric motor 102, where the rotational speed is increased to a maximum rotational speed and then cycled to a minimum rotational speed.

Referring to FIGS. 1, 5, and 8, the battery pack coupling portion 1011 is located on the rear side of the housing 101, and the operation key 109 is located on the front side of the housing 101 to be convenient to operate during hand grip. Specifically, the housing 101 includes a grip 1012, and the position of the operation key 109 does not interfere with the grip 1012. The operation key 109 is disposed at the top, on a side, or at the front end of the housing 101. The operation key 109 may be a rocker switch, a signal switch plus a paddle trigger, or a membrane switch, which is not limited here.

Referring to FIG. 12, the sander further includes a display screen 110, the battery pack coupling portion 1011 is located on the rear side of the housing 101, and the display screen 110 is located on the front side of the housing 101. To obtain a better viewing angle, the display screen 110 may be disposed at a position convenient for the user to see, for example, at the top, on a side, or at the front end of the front side of the housing 101. In FIG. 12, A1, A2, and A3 indicate positions where the display screen 110 can be disposed. Of course, the position of the display screen 110 is not limited here as long as the display screen 110 does not interfere with other components. If the display screen 110 is disposed in a region where the grip 1012 is located, the display screen 110 is embedded into the housing 101 so that a display interface is recessed a set distance relative to a surface of the housing 101, so as to prevent the display screen 110 from being pressed during hand grip. The display screen 110 may be a light-emitting diode (LED) screen or a liquid crystal display (LCD) screen.

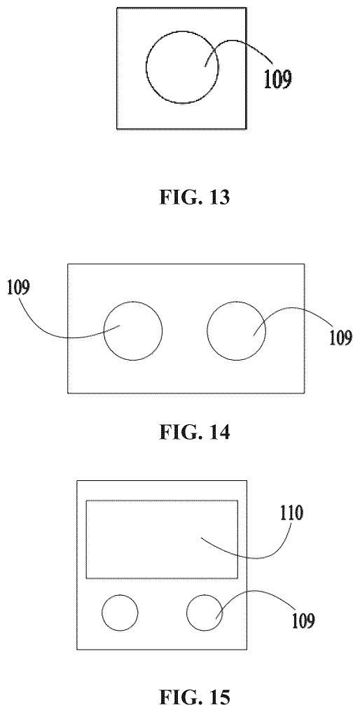

Referring to FIGS. 13 and 14, in an example, the operation key 109 is an operating system into which a key function, an indication element, and an instrument panel are integrated. The operation key 109 may include at least one key. In an example, the operation key 109 may include one membrane switch or two membrane switches. An indication element of the membrane switch may be a display light and specifically an LED light. A current state of the tool is indicated by a change in a color or flashing frequency of the display light.

In an example, the membrane switch is long or short pressed so that different functions can be implemented, or the membrane switch is pressed different times so that different functions can be implemented. For example, the membrane switch is pressed once for startup, pressed once again for gear shift, and long pressed for a period of time (is to 2s) for shutdown. In another example, two membrane switches are provided, one membrane switch may control the startup and shutdown, and the other membrane switch may control speed regulation. The two membrane switches each have a key LED, the membrane switch for controlling the startup and shutdown can indicate an operating state and power of the tool, and the membrane switch for speed regulation can indicate a current gear, for example, red indicates a first gear, blue indicates a second gear, and so on.

The membrane switch with an LED indication function may also be used for warning an abnormal state of the tool. The abnormal state here may refer to overload protection. That is to say, when the sander is in the abnormal state, the user is reminded through different frequencies of an indicator light. For example, when the sander is overloaded, a red light flashes at 5 Hz; and when the battery pack has an insufficient voltage, the red light flashes at 1 Hz.

Referring to FIG. 15, the operation key 109 and the display screen 110 may both be disposed, or the display screen 110 may be disposed alone. The display screen 110 may be a touchscreen convenient to touch. That is to say, the display screen 110 has a touch interface or a human-machine operation interface. The display screen 110 may display a speed gear in a current working mode; an actual rotational speed in the current working mode may be intuitively fed back to the user; and power information of the battery pack 200 of the sander, a speed gear increase or decrease button, and possible wireless Bluetooth communication information between the sander and a vacuum cleaner may also be displayed. The sander may also have a one-key acceleration function, that is, a key is pressed once to directly adjust the sander to the maximum rotational speed.

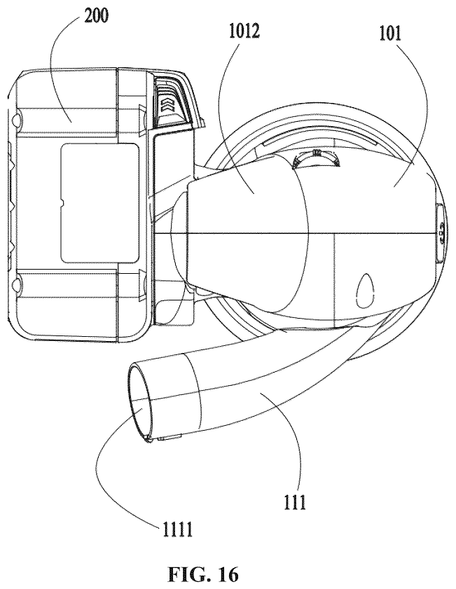

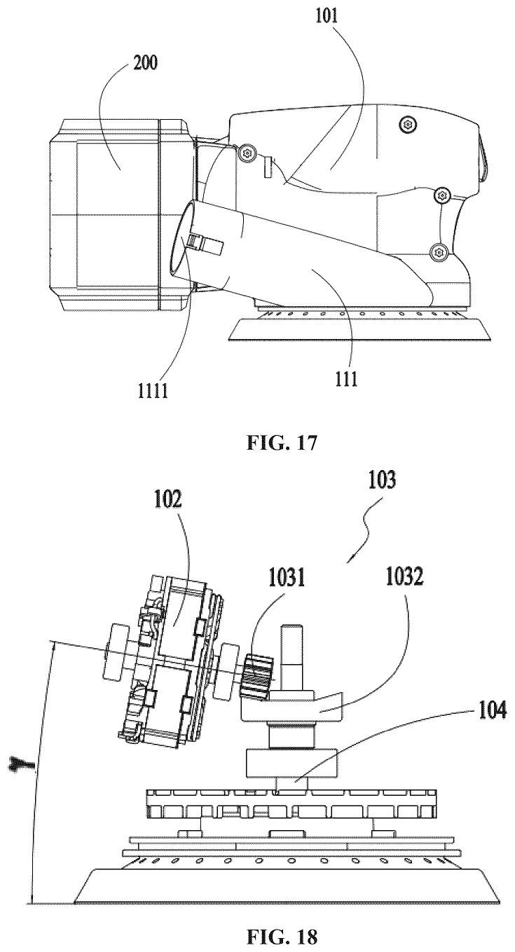

Referring to FIGS. 16 and 17, an air duct 111 is provided on the housing 101, an air outlet 1111 is provided at an end of the air duct 111, the air outlet 1111 faces the rear side of the housing 101, and the air duct 111 extends in an arc shape in a direction away from the housing 101. Thus, the air outlet 1111 does not face an operator, an air outlet path is smooth, and an air outlet speed is fast. Specifically, as shown in FIG. 17, the air duct 111 extends upward obliquely in a direction away from the base plate 105 so that the air outlet 1111 faces the rear side of the housing 101 and does not face the operator.

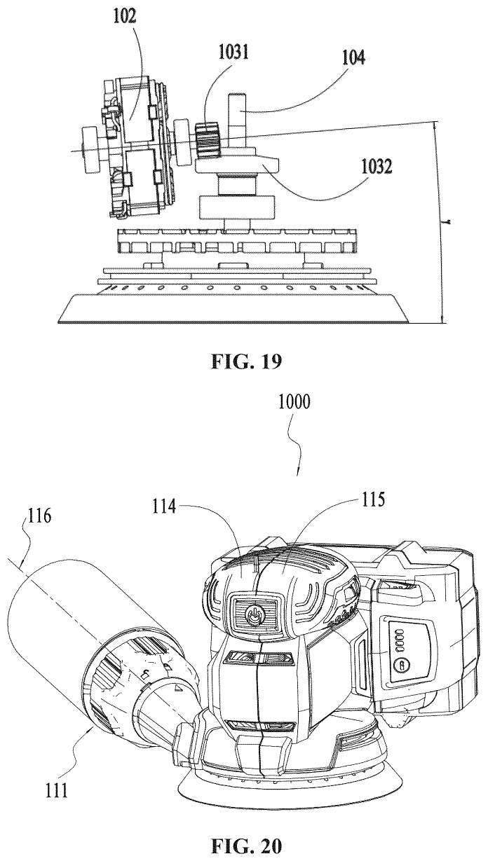

FIGS. 18 and 19 show other manners in which the electric motor is arranged, that is, the angle between the axis of the motor shaft 1021 and the axis of the output shaft 104 is an acute angle or an obtuse angle. The transmission assembly 103 is the bevel gear transmission assembly and includes the first bevel gear 1031 and the second bevel gear 1032 that mesh with each other, the first bevel gear 1031 is connected to the motor shaft 1021, and the second bevel gear 1032 is connected to the output shaft 104. The first bevel gear 1031 and the second bevel gear 1032 are both helical gears.

The angle γ between the axis of the motor shaft 1021 and the plane where the base plate 105 is located is greater than 0° and less than or equal to 25°. Thus, space can be fully utilized, and the stability of the electric motor 102 can be ensured. In some examples, the angle γ is 30, 5°, 8°, 10°, or 15°.

As shown in FIG. 1, in an example, the battery pack 200 is configured to be inserted horizontally. That is to say, when the battery pack 200 is mounted to the body 100, the height of the battery pack 200 in an up and down direction is less than or equal to the length of the battery pack 200 in the left and right direction. “Up”, “down”, “left”, and “right” here refer to directions of the whole machine 10 of the sander in FIG. 1.

In one aspect, the present application discloses that the motor shaft 1021 and the output shaft 104 are not coaxial, and the angle γ between the axis of the motor shaft 1021 and the plane where the base plate 105 is located is limited. In the other aspect, the battery pack 200 mounted to the body 100 has a relatively small height. Thus, the height H of the whole machine 10 is less than or equal to 105 mm so that the sander is compact in structure and relatively small in volume and occupies a small space. In an example, the height H of the whole machine 10 is less than or equal to 100 mm. In some examples, the height H is 100 mm, 98 mm, or 96 mm.

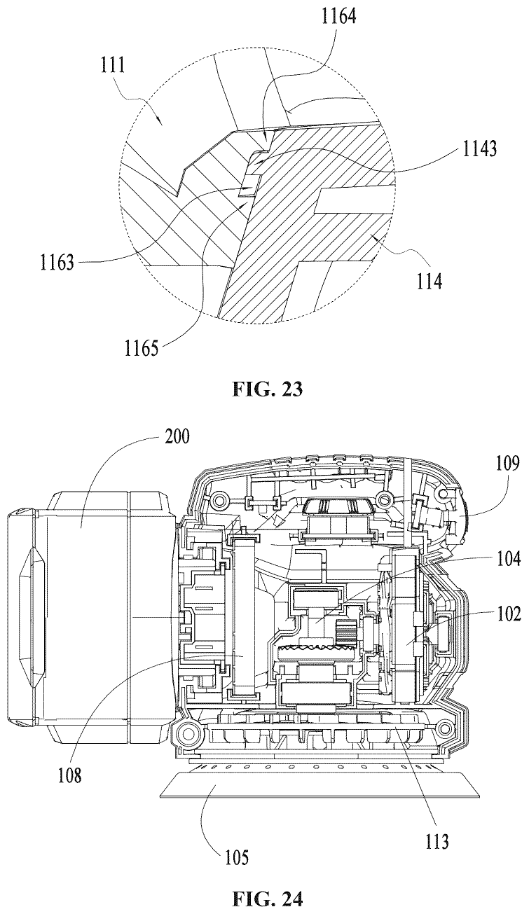

FIGS. 20 to 26 show another example of a sander 1000 of the present application.

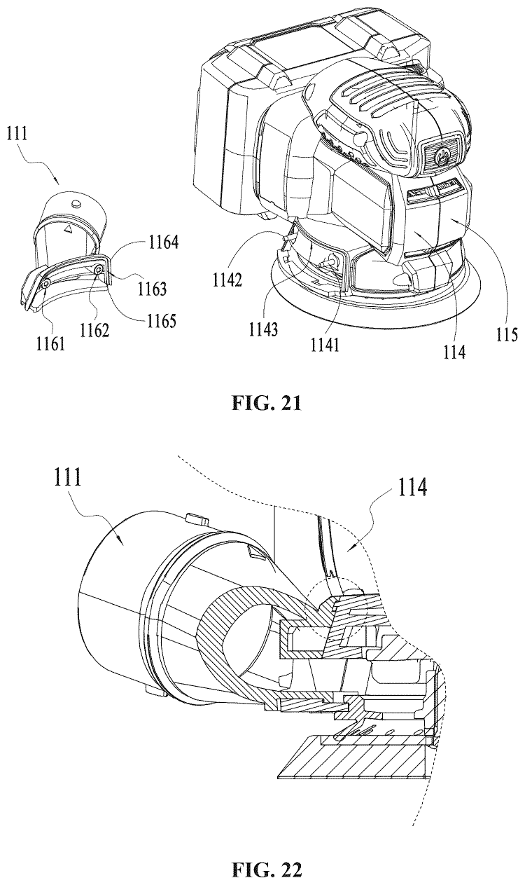

As shown in FIGS. 20 and 21, the housing 101 includes a first housing 114 and a second housing 115, and the first housing 114 and the second housing 115 form two half housings: a left housing and a right housing that jointly accommodate the electric motor 102, the output shaft 104, the control board 108, a fan 113, and the like. The first housing 114 is connected to the air duct 111, and a dust outlet housing forms a receiving space for the dust absorbed from the base plate 105 to pass through. The air duct 111 extends along a direction of a first straight line 116, and the angle between the first straight line 116 and the base plate 105 is greater than 100 and less than 30°. In some examples, the angle between the first straight line 116 and the base plate 105 may be 15°, 20°, or 25°.

As shown in FIG. 21, the air duct 111 is mounted at a position of the first housing 114 close to the base plate 105. In this example, the air duct 111 is connected to the first housing 114 by screws. The air duct 111 is provided with mounting holes including a first mounting hole 1161 and a second mounting hole 1162. A first screw 1141 penetrates through the first housing 114 and is tightened in the first mounting hole 1161, and a second screw 1142 penetrates through the first housing 114 and is tightened in the second mounting hole 1162.

As shown in FIGS. 21 to 23, the air duct 111 and the first housing 114 seal dust and air through male and female mating housing edges. The air duct 111 is provided with a sealing groove 1163 on the outer side of the mounting holes, the sealing groove 1163 is surrounded by two protruding edges, a first flange 1164 is adjacent to the outside of the air duct 111, and a second flange 1165 is adjacent to a dust outlet channel. The first housing 114 is provided with a sealing protrusion 1143 on the outer side of the screws, the sealing protrusion 1143 enters the sealing groove 1163, and the sealing protrusion 1143 is closer to the first flange 1164 to effectively seal a dust outlet airflow.

As shown in FIG. 24, the electric motor 102 is basically perpendicular to the output shaft 104, the control board 108 is basically parallel to the output shaft 104, the electric motor 102 and the control board 108 are located on two sides of the output shaft 104, the operation key 109 is located on the upper side of the electric motor 102, and the center of gravity of the whole machine is located between the battery pack 200 and the output shaft 104.

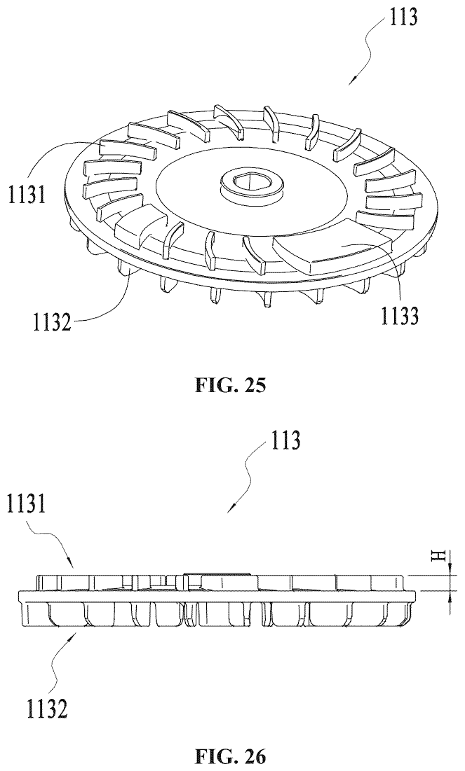

In conjunction with FIGS. 25 and 26, the fan 113 includes upper fan blades 1131 and lower fan blades 1132, the upper fan blades 1131 are configured to dissipate heat for the electric motor 102, the control board 108, and the output shaft 104, and the lower fan blades 1132 are configured to form negative pressure for dust suction so that the dust flows upward through the base plate 105. In the present application, it is set that the height H of the upper fan blades 1131 is less than or equal to 4 mm. In some examples, the height H of the upper fan blades 1131 may be about 3 mm, 3.2 mm, 3.4 mm, or the like. The height is so designed that in one aspect, the heat dissipation air volume provided by the upper fan blades 1131 can be guaranteed to satisfy the heat dissipation requirement of the sander, and in the other aspect, an energy loss caused by the rotation of the upper fan blades 1131 is reduced, and the battery life of the battery pack 200 is prolonged.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

### REFERENCE LIST

10 whole machine
100 body
101 housing
1011 battery pack coupling portion
1012 grip
102 electric motor
1021 motor shaft
103 transmission assembly
1031 first bevel gear
1032 second bevel gear
104 output shaft
105 base plate
106 bearing
107 gearbox
1071 box body
1072 cover
108 control board
109 operation key
110 display screen
111 air duct
1111 air outlet
112 speed regulation assembly
113 fan
1131 upper fan blade
1132 lower fan blade
1133 counterweight
114 first housing
1141 first screw
1142 second screw
1143 sealing protrusion
115 second housing
1161 first mounting hole
1162 second mounting hole
1163 sealing groove
1164 first flange
1165 second flange
1000 sander
200 battery pack
201 coupling surface
301 first plane
302 second plane

What is claimed is:

1. A sander, comprising:
a housing;
a battery pack coupling portion to which a battery pack is mountable;
an electric motor disposed in the housing and having a rotatable motor shaft; and
a base plate comprising a sanding bottom surface capable of performing sanding;
wherein an overall height H of the sander is less than or equal to 105 mm.

2. The sander according to claim 1, further comprising an output shaft, wherein the output shaft drives the base plate to rotate; and laminations of the electric motor are located between the battery pack and the output shaft.

3. The sander according to claim 1, wherein an angle γ between an axis of the motor shaft and a plane where the base plate is located is greater than or equal to 0° and less than or equal to 25°.

4. The sander according to claim 2, wherein, when the battery pack is mounted to the sander, a center of gravity of the sander is located between the battery pack and the output shaft.

5. The sander according to claim 2, wherein the overall height H is less than or equal to 100 mm.

6. The sander according to claim 2, further comprising a transmission assembly, wherein an input end of the transmission assembly is connected to the motor shaft, and an output end of the transmission assembly is connected to the output shaft.

7. The sander according to claim 1, further comprising an output shaft, wherein the output shaft drives the base plate to rotate; the battery pack is mountable to the battery pack coupling portion; on a plane parallel to the base plate, an axis of the output shaft is defined as a center, and, with a Y axis being parallel to a mounting plane of the battery pack and an X axis being perpendicular to the Y axis, an angle α between an axis of the motor shaft and a positive direction of the X axis is greater than or equal to 20°.

8. The sander according to claim 1, wherein an angle γ between an axis of the motor shaft and a plane where the base plate is located is greater than or equal to 5° and less than or equal to 15°.

9. The sander according to claim 1, wherein a control board is provided in the housing, and the motor shaft is spaced apart from the control board.

10. The sander according to claim 1, further comprising an operation key disposed at a top, on a side, or at a front end of the housing.

11. The sander according to claim 10, wherein the operation key is capable of controlling start and stop of the electric motor and/or regulating a rotational speed of the electric motor.

12. The sander according to claim 1, further comprising a display screen located at a top, on a side, or at a front end of a front side of the housing.

13. The sander according to claim 1, wherein, when the battery pack is mounted onto the battery pack coupling portion, a height of the battery pack in an up and down direction is less than or equal to a length of the battery pack in a left and right direction.

14. The sander according to claim 1, wherein an air duct is provided on the housing, an air outlet is provided at an end of the air duct, the air outlet faces a rear side of the housing, and the air duct extends in an arc shape in a direction away from the housing.

15. The sander according to claim 6, further comprising a gearbox, wherein the transmission assembly is disposed in the gearbox.

16. The sander according to claim 15, wherein a weight of the gearbox is greater than or equal to 20 g and less than or equal to 350 g.

17. A sander, comprising:
a battery pack; and
a body comprising a housing; a battery pack coupling portion to which the battery pack is mountable; a base plate; an electric motor disposed in the housing and having a rotatable motor shaft; and an output shaft for driving the base plate to rotate;
wherein, when the battery pack is mounted to the battery pack coupling portion, the body and the battery pack form a whole machine, a center of gravity of the whole machine is located between the battery pack and the output shaft, and an overall height H of the sander is less than or equal to 105 mm.

18. The sander according to claim 17, wherein a weight of the whole machine is defined as a first weight W1, a maximum weight of the battery pack mountable to the body is defined as M0, and M0 is greater than or equal to 40% of W1.

19. The sander according to claim 17, wherein a weight of the body is defined as a second weight W2, and W2 is greater than or equal to 800 g and less than or equal to 1100 g.

20. The sander according to claim 17, wherein a weight of the battery pack is greater than or equal to 700 g and less than or equal to 1300 g.
